(19) United States
(12) Patent Application Publication
(10) Pub. No.: US 2013/0247629 A1
(43) Pub. Date: Sep. 26, 2013

(54) PROCESSING METHOD FOR BIOLOGICAL MATERIAL TO PRODUCE A WATER-RETAINING POLYMER COMPLEX

(71) Applicant: Incinerator Replacement Technology Limited, Suffolk (GB)

(72) Inventors: Duncan Foster, Suffolk (GB); Michael Morris-Watson, Suffolk (GB); Arjomand Mohammadi Ghareghani, Hertfordshire (GB)

(73) Assignee: Incinerator Replacement Technology Limited, Suffolk (GB)

(21) Appl. No.: 13/895,793

(22) Filed: May 16, 2013

Related U.S. Application Data
(63) Continuation of application No. PCT/GB2011/052243, filed on Nov. 17, 2011.

(30) Foreign Application Priority Data
Nov. 17, 2010 (GB) 1019417.3

(51) Int. Cl. C05F 1/00

(52) U.S. Cl. CPC C05F 1/005
USPC 71/13; 71/22

(57) ABSTRACT

Provided herewith are a method of processing biological material into a water-retaining polymer complex, a water-retaining polymer complex obtained from said method, and the use of said water-retaining polymer complex to improve the water retention and/or nutrient content of soil. The method comprises providing said biological material, an alkaline solution and a monomer, then adding a polymerisation agent to form a water-retaining polymer complex.

### CROSS REFERENCE TO RELATED APPLICATION

This application is a continuation of International Patent Application No. PCT/GB2011/052243, filed on Nov. 17, 2011, which claims priority to United Kingdom Patent Application Serial No. GB 1019417.3, filed Nov. 17, 2010, the contents of both of which are hereby incorporated by reference in their entireties herein.

### FIELD OF THE INVENTION

The invention relates to the processing of biological material.

### BACKGROUND TO THE INVENTION

Following the Bovine Spongiform Encephalopathy (BSE) breakout in the 1980's, and the subsequent banning of the use of Meat and Bone Meal (MBM) in animal feed, there have been many attempts to make a useful end-product out of fallen stock. In Europe, some MBM is used as ingredients in pet-food. In addition, MBM is increasingly used as an environmentally sustainable replacement for coal for renewable energy generation or as a fuel in cement kilns. However, MBM has only around two thirds the energy value of fossil fuels such as coal. Therefore, unfortunately, a large proportion of MBM is simply put in land fill or incinerated.

The present inventors have looked to bridge the fields of MBM disposal/use and soil conditioning/fertilizing. Conventional inorganic fertilizers have the great disadvantage of being highly water soluble. This can lead to leaching of such fertilizer to ground water and which can cause significant environmental damages such as eutrophication. Organic fertilizers have their own problems, such as variable consistency. Much organic matter, especially meat, is not suitable as a fertiliser because it, for example, releases malodor (sometimes unbearable).

It is an object of the present invention to provide a solution to these problems.

### SUMMARY OF THE INVENTION

The inventors provide a method of processing biological material into a water-retaining polymer complex, said method comprising the steps of:
(a) providing a composition comprising said biological material, an alkaline solution and a suitable monomer; and
(b) adding a polymerisation agent to form a water-retaining polymer complex.

In preferred embodiments the biological material is derived from an animal and/or said alkaline solution is provided at a temperature of 50° C. or more.

In preferred embodiments the method further comprises one or both of the steps of drying the resultant water-retaining polymer complex and comminuting the resultant water-retaining polymer complex (preferably using cryogenic milling).

In preferred embodiments the composition further comprises a cross-linking agent and/or a further nutrient and/or an animal repellent.

In preferred embodiments the composition further comprises comminuted disposable diaper, and preferably soiled diaper. Disposable diapers (or “nappies”) comprise an assembly containing cellulosic material and often incorporate a water-absorbing gel, known as a “superabsorber” or suberabsorbent gel. Such superabsorbent-containing diapers are especially preferred. The disposal of such diapers, and especially if they are soiled with faecal matter, is problematic. The inventors have found that they may be added, in a comminuted state, to the composition before polymerisation. The alkaline nature of the composition acts to break down the structure of the cellulosic material, and also leads to reduction or elimination of pathogenic organisms that might be associated with the diaper material. Where superabsorbent polymer material is already present in the diaper, then this gives additional water holding capacity to the water-retaining polymer complex.

Preferably, any one of the above methods further comprises the step of comminuting the biological material prior to step (a), preferably wherein the method further comprises the step of freezing said biological material prior to said comminuting step (preferably using cryogenic freezing).

The inventors also provide a water-retaining polymer complex obtained from any one of the methods above, and the use of said water-retaining polymer complex to improve the water retention and/or nutrient content of soil.

### BRIEF DESCRIPTION OF THE DRAWINGS

The invention will be described with reference to the accompanying drawing, in which:

FIG. 1 shows CFU/g of four environmentally important bacteria and Total Viable Count (TVC) in organic waste (minced meat) at three different time points during the process of the invention: prior to (T₀—shown in black fill) and after KOH addition (T_{KOH}—shown in white fill) and after acrylic acid addition (Tₐₐ—shown in hatched fill). (CFU=colony-forming units); and

FIG. 2 shows a number of Infrared (IR) spectra to provide evidence of cross-linking between meat and polyacrylate.

### DETAILED DESCRIPTION OF PREFERRED EMBODIMENTS

The invention concerns the processing of biological material, which is any material that is derived from or forms part of an organism. For example, said biological material is plant material or (dead) animal or human material, or a mixture of these materials. Preferably, the biological material is proteinaceous (i.e. comprises or consists essentially of protein), preferably comprising fibrous protein (such as, for example, meat). In particularly preferred embodiments, the biological material is derived from an animal, is preferably animal tissue, and preferably comprises fibrous protein (preferably comprising or consisting essentially of animal meat).

The claimed processing method converts biological material into a water-retaining polymer complex that, for example, aids the handling, transport and disposal of such material (e.g. biological waste). In preferred embodiments the method substantially reduces or essentially eradicates pathogens from within the biological material. The method therefore provides a safe means by which dead humans or animals (or parts thereof) can be disposed, especially in the case where said humans or animals are infected with a pathogenic agent (such as a prion, a virus, a bacterium or a fungus). The method is particularly useful in the setting of agriculture and food processing, where fallen stock (culled stock that is unfit for human consumption due to e.g. injury or infection) or unwanted animal body parts (e.g. from an abattoir, slaughterhouse, butcher or restaurant) need to be quickly and safely disposed of. Particular stock animals envisaged include chicken, turkey, goose, duck, pheasant, pig, cow, sheep, goat and horse.

Furthermore, the claimed method can be used to process biological material comprised within household waste, especially that derived from meat, vegetables and fruit.

The claimed method is self-heated and hence environmentally friendly. In addition, the complex produced according to the claimed method can be used to improve the properties of soil e.g. as a conditioner and/or fertilizer (though this use may be restricted to cases where the biological material has not been derived from a human). In this way waste material e.g. from fallen stock can be put to constructive use. Indeed, the water-retaining polymer complex of the invention provides a number of particular advantages in relation to conventional materials for soil improvement, as discussed in detail below.

### The Method of the Invention

The claimed method involves providing a composition comprising the biological material to be processed, an alkaline solution and a suitable monomer. The alkaline solution might be, for example, a hydroxide-based solution (e.g. KOH, NaOH or NH₄OH). A typical concentration would be e.g. about 30% but concentrations also contemplated are those in the range 5-95%, preferably 5-75%, more preferably 10-50%, and most preferably 20-40%. A solution comprising NH₄OH is preferred if increasing the nitrogen content of the polymer complex is important. A solution comprising KOH is preferred if increasing the potassium content of the polymer complex is important. Such increases may be important for providing a desired N:P:K ratio for a fertilizer. Otherwise, a combination of KOH and NaOH provides a particularly good water-retention (especially in a ratio of about 5:1).

Biological material is included in the composition at about 1:1 (w/v of biomaterial: other components), though ratios also contemplated include between 1:100 and 5:1, preferably between 1:50 and 5:1, more preferably between 1:20 and 2:1, more preferably between 1:10 and 2:1, more preferably between 1:2 and 2:1.

A suitable monomer is any monomer that polymerises to form a water-retaining polymer and options include acidic monomers, such as those that are alkene-based such as acrylic acid, acrylamide or vinyl alcohol, but the skilled addresse could identify other alternatives e.g. ethylene oxide. In preferred embodiments only a single type of monomer is used in order to simplify the procedure. The ratio of monomer to biological material can be selected according to the identity of both entities, though for guidance suitable ratios (w/v) for e.g. minced meat to acrylic acid are from 100:1 to 1:2, more preferably from 50:1 to 2:3, more preferably from 10:1 to 1:1, more preferably from 10:1 to 2:1, most preferably about 10:3.

In preferred embodiments the biological material is combined with the alkaline solution before the monomer is added. The alkaline conditions of the solution provide an antimicrobial effect, and this effect is potentiated at elevated temperature, e.g. at 40° C. or more, preferably at 50° C. or more, more preferably at 60° C. or more. This elevated temperature can be obtained by direct heating of the solution but more preferably it is provided by the preparation of the alkaline solution just prior to the addition of the biological material—such preparation is exothermic and can raise water temperature e.g. from 23° C. to 60° C. If an elevated temperature is to be maintained after combination with the biological material, exogenous heat may need to be supplied depending on the ratio and temperature of biological material combined with the alkaline solution. The subsequent combination with the monomer may also be exothermic and thus can contribute to the antimicrobial effect of the method (especially with acidic monomers).

In preferred embodiments the composition further comprises a cross-linking agent, such as ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, N,N′-Methylenebisacrylamide, N,N′-(1,2-dihydroxyethylene) bisacrylamide, divinylbenzene or N-(1-hydroxy-2,2-dimethoxyethyl) acrylamide. These agents are typically used at 0.01% and serve to cross-link the biopolymers in the biological material. It is expected that the use of such cross-linking agents will increase the water holding capacity of the polymer complex by 10-20%.

In preferred embodiments the composition further comprises a further nutrient, that is any substance of nutritional value to a plant that does not derive from the biological material to be processed. The further nutrient may be organic or inorganic, the latter including a source of nitrogen, phosphorous and/or potassium (e.g. ammonium phosphate).

In preferred embodiments the composition further comprises an animal repellent, especially a chemical repellent, such as grape musk, methyl anthranilate or ortho-aminoacetophenone.

The claimed method then involves adding a polymerisation agent to the composition described above (or vice-versa) to form a water-retaining polymer complex. The skilled addresse will be able to select a suitable polymerisation agent (and amount thereof), depending on e.g. the monomer used. For example, when using acrylic acid as the monomer, suitable agents include ammonium persulphate and tetramethylethylenediamine (TEMED) (e.g. 0.5 g or 0.3 g, respectively, for a mix formed from 100 ml 30% alakaline solution, 100 g minced meat and 30 ml acrylic acid).

In preferred embodiments, the method of the invention further comprises the step of drying the resultant water-retaining polymer complex and/or comminuting said complex, preferably wherein said comminuting is effected using cryogenic milling, for example using liquid nitrogen. Comminuting of the polymer complex breaks it down into polymer complex particles that are smaller in size and larger in surface area. This can aid handling, disposal or distribution of the polymer complex, and is especially useful when the complex is to be dispersed onto fields (where the increased surface area promotes water-retention and eventual nutrient release).

### The Resultant Water-Retaining Polymer Complex and Its Uses

The method of the invention can process biological material into a complex that can be substantially free of viable pathogenic agents, such as prions (e.g. that which causes BSE and scrapie), viruses, bacteria (e.g. B. cereus, S. aureus, S. typhimurium and E. coli) and/or fungi. It thus enables the conversion of biological material into a form that is easier and safer to handle, transport and dispose of.

In addition, however, the complex produced by the method of the invention has properties that enable it to be used in agriculture. For example, the complex has surprisingly high water-retaining capacity, making it suitable for improving the water retention of soil (often referred to as “conditioning” soil).

Furthermore, the complex has high nutritional value, derived from the components of the biological material that has been processed, and is therefore suitable for improving the nutrient content of soil (often referred to as “fertilizing” soil). For example, if the biological material comprises protein then the resultant complex can deposit protein and/or amino acids into the soil. The structure of the complex ensures that such deposition is slow release (providing efficient nutrient provision whilst reducing the negative environmental impact of leaching). In addition, the process of the invention results in a degradable material that does not release substantial malodor, in contrast to untreated biological material (e.g. meat) that releases substantial malodor upon degradation.

A further characteristic of the polymer complex is that it has a pH of 7.7. This makes it suitable for use as a liming agent (i.e. to increase the pH of an acidic soil). However, the pH of the polymer complex could be adjusted after its formation to make it suitable for any intended use.

### Methods of Preparing Material for the Method of the Invention

In preferred embodiments the biological material is processed before it is incorporated into the alkaline solution so as e.g. to increase its solubility. For example, the biological material might be comminuted, for example by cryogenic milling, grinding, crushing, slicing, or a mixture thereof (e.g. using a macerator). To aid such comminution the biological material is preferably frozen beforehand, preferably by cryogenic freezing (e.g. using liquid nitrogen). This step has the further advantage of reducing the degradation of and/or spread of pathogenic agents from the biological material prior to its incorporation into the water-retaining polymer complex.

Such embodiments are particularly envisaged for the agricultural setting, where fallen stock can be frozen and/or comminuted prior to processing (which may occur at the same locality). In particularly preferred embodiments biological material (e.g. fallen stock) is placed with a steel (preferably stainless) container lined (partly or fully) with cardboard and submerged (partially or totally) in liquid nitrogen. Once the liquid nitrogen has evaporated the frozen biological material can be comminuted via any conventional means (e.g. crushing—for which a roll packer may be particularly effective).

### EXAMPLES

### 1. Production of a Meat-Based Water-Retaining Polymer Complex

100 ml of a 30% alkaline solution was made up (5 g KOH and 25 g NaOH). Water temperature went up from 23° C. to 60° C. during this (exothermic) process. 100 g of organic waste (minced meat) was dissolved in the solution, reducing the temperature of the solution to 55° C. The high temperature and high alkaline conditions of the solution can lead to 6 logs Total Viable Count reductions (see below). Once the temperature of the solution fell to 45° C., 30 ml acrylic acid was added. This raised the temperature to 62° C. After 5 minutes, 0.5 g ammonium persulphate (APS) was added as polymerizing agent to the solution and polymerization took place within 15 minutes. The addition of APS to the solution raised the temperature of the solution to 70° C. The resultant complex had a pH of 7.7.

### 2. Water Holding Capacity (WHC) of the Meat-Based Water-Retaining Polymer Complex

In order to measure the WHC of the end product, 20 g of dried polymer complex was saturated with purified, deionized water. The polymer was filtered using 25 cm Whatman filter paper (quantitative no. 6) in a funnel. The wet filter paper was weighed first and after 15 minutes once the water dropping had stopped, the polymer and filter paper were weighed again and the weight of a wet filter paper was subtracted. WHC could then be calculated as following:
Wet Filter paper=0.3254 g
Wet Filtered paper+Saturated polymer=529.1736 g
529.1736 g−0.3254=528.8482 g saturated polymer mass
528.8482 g−20 g=508.8482 g water in 20 g polymer
20 g polymer can hold—508.8482 g
   Therefore 1 g of polymer can hold 25.4 g of water

### 3. Rottability of the Meat-Based Water-Retaining Polymer Complex

2 g of raw meat and 2 g of polymer complex were placed in two separate petri dishes. 15 ml of maximum recovery diluent was added to 1 g of soil and shaken for 2 minutes to extract a wide range of soil micro-organisms. 5 ml of this extract was added to each petri dish and incubated at 25° C. for 5 hours. The petri dish containing raw meat emitted a bad odour while the polymer complex produced no undesirable smell.

### 4. Microbial Eradication During the Production Process

Four representative bacteria were used: Bacillus cereus (sporogenic, gram positive), Staphylococcus aureus (non-sporogenic, gram positive), and Sallmonella typhimurium and Escherichia coli (both non-sporogenic, gram negative). Each of the above mentioned bacteria was inoculated into 100 g of organic waste (minced meat) and mixed thoroughly in 100 ml distilled water with a magnetic stirrer. Samples were taken before (T₀) and after (T_{KOH}) addition of 25 g of NaOH and 5 g of KOH, and again after acrylic acid (before addition of polymerising agent) (Tₐₐ). Four samples were taken at each sampling point and the most outlying sample disregarded.

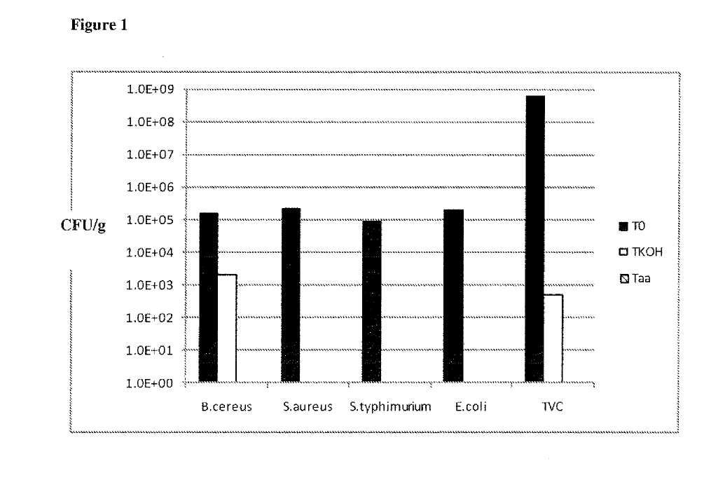

Samples were analysed with selective, nutrient agar (37° C.) for the individual bacteria and for total viable count (TVC). The selective agars used were B. cereus selective agar, Vogal-Johnson, XLD and violet red bile (all purchased from Oxoid, UK) to detect B. cereus, S. aureus, S. typhimurium and E. coli, respectively. The results are shown in FIG. 1.

The addition of alkaline to the solution (with corresponding sharp increase in temperature) led to a significant reduction in microbial populations (5-6 logs). The gram negative bacteria (E. coli and S. typhimurium) were eradicated at that stage. Although B. cereus population has also dramatically decreased, it shows persistency at that stage. At the end of the process there is a total eradication of all microbial populations due to the addition of acrylic acid to the solution.

### 5. Energy Release During the Production Process

To measure the energy release from the process, the following formula was used:
Q=MCΔT
   Where Q is the quantity of heat released in joules or calories
M is the mass of the material being heated
C is specific heat capacity in J/g° C. or cal/g° C.
ΔT is difference in temperature in ° C. or ° F.

100 ml of water was added to 100 g of minced meat. Temperature at that stage was 24° C. After addition of 30 g KOH, temperature rose to 44° C.

Therefore, from the first stage 4600 calories are released.

Q₁=M₁CΔT Q₁=230 g*1 cal/g° C.*(44−24)=4600 calories

When temperature dropped down to 40° C., 30 ml of acrylic acid was added. Temperature increased to 56° C. Therefore, 4160 calories is released at that stage:

Q₂=M₂CΔT Q₂=260 g*1 cal/g° C.*(56−40)=4160 calories

0.5 g of APS was added when temperature was 53° C. Temperature went up to 60° C. as a result. Therefore, 1820 calories of energy is released at that stage:

Q₃=M₃CΔT Q₃=260 g*1 cal/g° C.*(60−53)=1820 calories

Qₜₒₜₐₗ=4600+4160+1820=10580 calories or 10.6 Kcal

Therefore 10.6 Kcal energy is released to produce 260 g of wet end product.

### 6. Evidence of Cross-Linking Between Meat and Polyacrylate

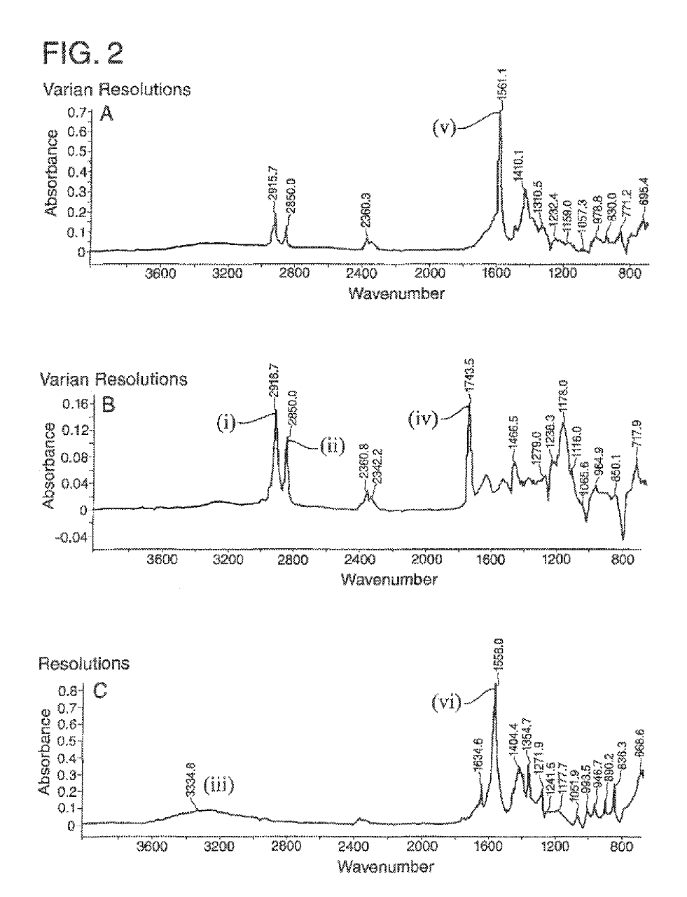

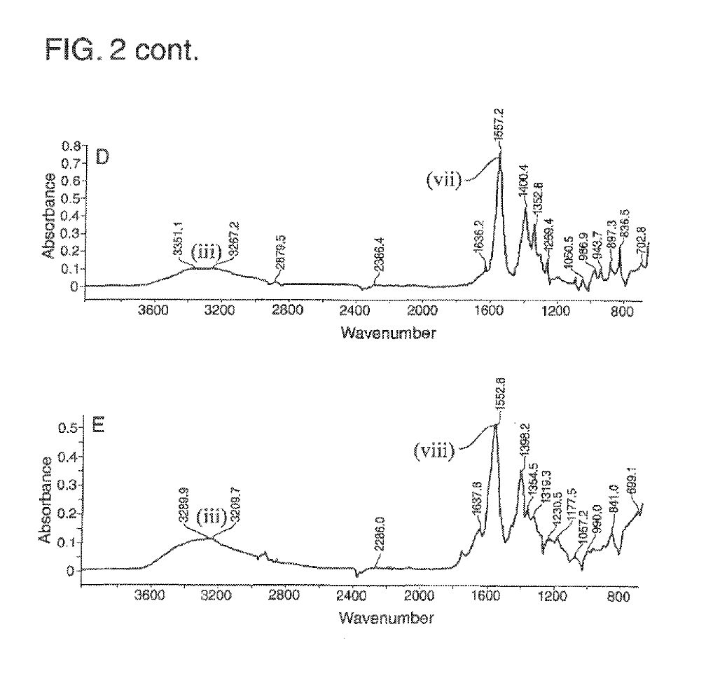

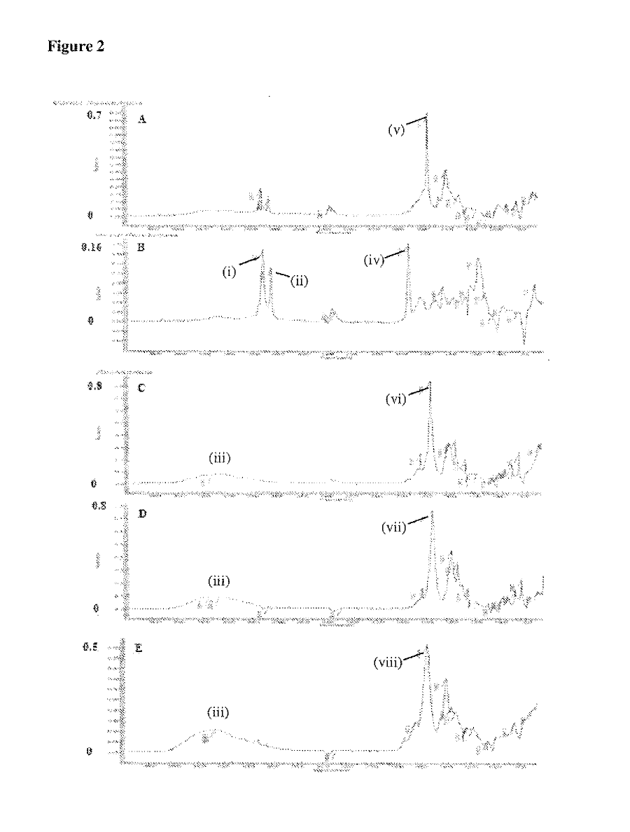

FIG. 2 shows IR spectra (absorbance versus wavelength) for A) hydroxylated meat, B) raw meat, C) hydroxylated meat combined with acrylic acid (without ammonium persulfate addition), D) poly sodium (potassium) acrylate and E) the meat-based water-retaining polymer complex as prepared above (i.e. hydroxylated meat combined with acrylic acid and polymerised with ammonium persulfate).

Absorbance at 2916.7 cm⁻¹ and 2850.8 cm⁻¹ in raw meat (see (i) and (ii)) corresponds to the peptide —NH group. These peaks disappear following hydroxylation. This is expected as —NH groups are replaced by —OH due to hydroxylation.

Addition of acrylic acid to the hydroxylated meat increases it is water retaining capacity, as shown by C to E. Despite keeping the samples at 30° C. for a week to keep them dry (following an initial overnight drying step at 70° C.), samples containing acrylic acid had absorbed the low level of moisture in the oven and water retention is shown by the peak at 3267-3251 cm⁻¹ (see (iii)) which correspond to the water —OH group.

Absorbance for the peptide C═O group appears at 1743.5 cm⁻¹ in raw meat (see (iv)). However, when this group is hydroxylated the peak shifts to 1561.1 cm⁻¹ (see (v)). When acrylic acid is added to the hydroxylated meat the absorbance peak shifts again, to 1558.0 cm⁻¹ (see (vi)). Only one peak is seen for the peptide C═O group in hydroxylated meat with and without acrylic acid that is similar to the absorbance seen in poly sodium (potassium) acrylate at 1557.7 cm⁻¹ for its ester C═O group (see (vii)). The absorbances at (v) to (vii) all have similar intensity, of 0.7-0.8. However, once ammonium persulfate is added as polymerising agent, C═O absorbance and its intensity decreases dramatically to 1552.8 cm⁻¹ and 0.5, respectively (see viii)). This is strong evidence of cross linkage between meat particles and polyacrylate as the absorbance and its intensity for the C═O group is unique. If there were only reactions between acrylate monomers without meat particles being chemically involved, then C═O absorbance and intensity would have been similar to poly sodium (potassium) acrylate and hydroxylated meat with acrylic acid.

What is claimed is:

1. A method of processing biological material into a water-retaining polymer complex, said method comprising:
(a) providing a composition comprising said biological material, an alkaline solution and a suitable monomer; and
(b) adding a polymerisation agent to form a water-retaining polymer complex.

2. The method of claim 1, wherein said biological material is derived from an animal.

3. The method of claim 1, wherein said biological material comprises fibrous protein.

4. The method of claim 1, wherein said alkaline solution is provided at a temperature of 50° C. or more.

5. The method of claim 1, wherein said alkaline solution comprises a hydroxide-based solution.

6. The method of claim 1, further comprising drying the water-retaining polymer complex.

7. The method of claim 1, further comprising comminuting the water-retaining polymer complex.

8. The method of claim 7, wherein said comminuting is selected from the group consisting of cryogenic milling, grinding, crushing, slicing, and a combination thereof.

9. The method of claim 1, wherein said composition further comprises a cross-linking agent.

10. The method of claim 1, wherein said composition further comprises a further nutrient.

11. The method of claim 1, wherein said composition further comprises an animal repellent.

12. The method of claim 1, further comprising comminuting said biological material before it is incorporated into said alkaline solution to form said composition.

13. The method of claim 12, further comprising freezing said biological material prior to said comminuting.

14. The method of claim 13, wherein said freezing comprises cryogenic freezing.

15. The method of claim 1, wherein said composition further comprises a comminuted disposable diaper.

16. The method of claim 15, wherein said diaper is soiled.

17. A water-retaining polymer complex obtained from the method of claim 1.

18. Use of the water-retaining polymer complex of claim 17 to improve the water retention of soil.

19. Use of the water-retaining polymer complex of claim 17 to improve the nutrient content of soil.
